(19) United States
(12) Patent Application Publication
(10) Pub. No.: US 2005/0047589 A1
(43) Pub. Date: Mar. 3, 2005

(54) User definable adhesive personal electronics cover

(76) Inventor: Yuan Chang, Burlingame, CA (US)

Correspondence Address: Yuan Chang, 2309 Ray Drive, Burlingame, CA, 94010, US

(21) Appl. No.: 10/647,575

(22) Filed: Aug. 26, 2003

(51) Int. Cl. H04M 1/00

(52) U.S. Cl. 379/452

(57) ABSTRACT

An Improved protective, functional, and aesthetically enhancing cover consisting of a pre or uncut sheet of any material that may be customized digitally or by other means and adhered to, enclosed by or otherwise attached to a cellular phone or other electronic device altering or enhancing pattern, color, functionality, and aesthetic, protective, or otherwise functional texture by any means including integration of circuitry as well as affording the integration of clip devices and other methods of adhering the electronic device to other objects.

### BACKGROUND OF THE INVENTION

1. Field of the Invention

The invention is a protective, functional, and aesthetically enhancing cover consisting of a pre or uncut sheet of any material that may be customized digitally or by other means and adhered to, enclosed by or otherwise attached to a cellular phone or other electronic device therefore altering or enhancing pattern, color, functionality, and aesthetic, protective, or otherwise functional texture as well as affording the integration of clip devices and other methods of adhering the electronic device to other objects.

2. Description of the Related Art

Pervasive today are interchangeable faceplates for cellular phones. Typically these plates are rigid, paired, and are colored by films and doping processes. They are fashioned to interlock with each other or the slightly smaller inner casing of the subject cell phone and are perforated to allow continued user access to screens and input keys.

In operation, the faceplate and its constituent pieces are interlocked with each other around the inner casing of the cell phone by means of sliding hook and eye clip assemblies located around the perimeter of the pieces. In other cases [See Nokia 3360 Faceplate] the faceplates lock into hook and eye clips located on each other around the inner casing but are secured by a hook clip into the inner casing by a spring mounted eye allowing for ease of separation. This design is very much prone to damage from fluids as it is not so sealed, especially around it's keys which its form is predominantly crowded with. The faceplates come in very limited and non interactive prints, forcing the user to compromise his or her choice of style for their own devices, and therefore greatly diminishing the great and untapped economic potential of the design. Though moderately ergonomic, the faceplates offer very little grip, critical for increasingly minute devices. The faceplate also does not facilitate any additional impact resistance outside of the minimal protection of a thin plastic shell through which impacts and concussions easily damage screens and other delicate electronic components as well as the very hook and eye assemblies that render the entire design effective at all.

Another personal electronics casing well deserving of recognition is the flexible and weather sealed impact resistant sleeve [See Body Glove's “Cellsuit” Phone Sleeve 3300]. The sleeve is a pairing of waterproof neoprene and clear polyurethane with a Velcro flap facilitating the sealing of the cellular phone against impacts and light direct water exposure. However it is inevitable that the Velcro would wear down or fail due to a high amount of snagging with regular use when attached by a clip thus defeating the purpose of the case. The impact resiliency of the design is hindered by large thin portions of the case comprised by clear polyurethane which allows for reasonable, though glare-hindered, viewing of displays as well as damaging concussions to pass through nearly uninhibited . The neoprene material used in manufacture is also prone to scuffing and fiber damage with time, diminishing the aesthetics, of which are limited by the inelastic choices of color and pattern available to the consumer, again with economic penalties.

### SUMMARY OF THE INVENTION

The invention is a pre or uncut sheet of any material that may be customized digitally or by other means and adhered to, enclosed by or otherwise attached to a cellular phone or other electronic device by altering or enhancing pattern, color, functionality, texture, aesthetics, and protective, or otherwise functional texture by means of inks, films, stencil cutting, integrated circuits, integrated textured materials, or doping processes as well as affording the integration of clip devices and other methods of adhering the electronic device to other objects.

Perhaps the greatest benefit of this invention is its absolute customizability of its qualities, because this case is adhereable and sheet based, it can integrate a never before possible factor for user customization of aesthetic design and functionality. The sheet is perforated in a manner consistent with its three-dimensional counterpart cellular phones as well as other device's traits such as a cut space from which the screen, audio, input/output, or lens may function. The sheet of the users choice may also be integrated with circuitry, films, shock absorbent sub-sheets, doping processes, or functional texture, affecting and enhancing the total function of the case and device. The sheet is then passed through a printer linked to a computer and appropriate software which will allow the user to integrate his or her own graphics or other aesthetic elements into the sheet and after removal from the sheet by means of the perforations or other method of removal from the base sheet, the user possesses a new and customized case that is as snugly adhered to the electronic device as physically possible. The buttons and input portions of the device are now sealed completely from entry of chemicals and humidity. The input portions may now be of a user defined texture, thickness, and are altogether improved from its previous state. The sheet may be of a clear, glare-proof, gripping material, or any combination of these and others facilitating enhanced visual data display as well as a newly grip-assured and shock absorbent shield for other internal components.

### DESCRIPTION OF DRAWINGS

FIG. 1 and FIG. 2 demonstrate the Velcro closure mechanism 1A and 2A, show the invention open and closed respectively. FIG. 2 displays in 2D the thin and glare-prone polyurethane segment of the cell case. 2E displays the neoprene segment of the cell case and how it is open and unproductive on all comers. FIG. 3 provides an exploded view of Nokia's 3360 phone case in relation to its internal component casing, all of which are molded of inflexibly colored and rigid polyurithanes. 3A represents hooks that lock into 3B's eyes. Similarly 3D's hooks lock into 3E's eyes. 3C represents a sensitive spring-mounted internal pressure toggle that allows for the assembly to remain together relatively securely, but very easily falls victim to routine jarring and concussions. FIG. 4 represents the digitally edited and printed-upon sheet of adhesive material mounted on its removable backing (4A). 4B represents the neutrally colored adhesive polyurethane or other material that the digitally designed pattern is printed over by a non intrusive stencil of the electronic device perforated along its outermost edges (4C). 4D represents the highlighted and optionally removable perforation that marks the case removal toggle button. 4E represents the digitally alterable markings of the devices input buttons that may also be altered by a choice of textures and protrusions integrated into the base sheet. 4F represents a clear, glare-proof, and protective section of the base sheet to accommodate and enhance the screen of the device. 4G represents slightly protruding and somewhat textured portions of the base sheet that will protect the device from concussions along the most vulnerable areas and provide textures that will enhance grip and aesthetic styling throughout. 4H represents a removable sliver that facilitates the uninhibited operation of the sound output device. FIG. 5 demonstrates how the perforated segment of the adhesive sheet fits around the electronic device in two pieces allowing for continued disassembly for maintenance of internal components. 5A represents how the protruding and textured integrated segments protect the corners of the device from concussions. 5B represents how the perforated area around the sound output device allows for uninhibited use with minimum aesthetic intrusion. 5C represents how the adhesive case does not interfere with electronic input or output ports. 5D represents how the protrusions from the case material provide enhanced aesthetics, shock absorption, and grip to the input buttons of the electronic device.

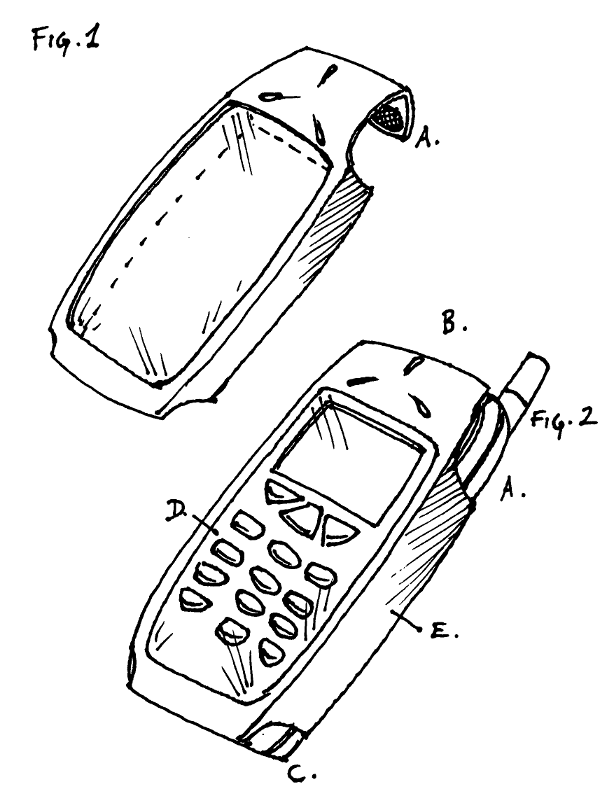

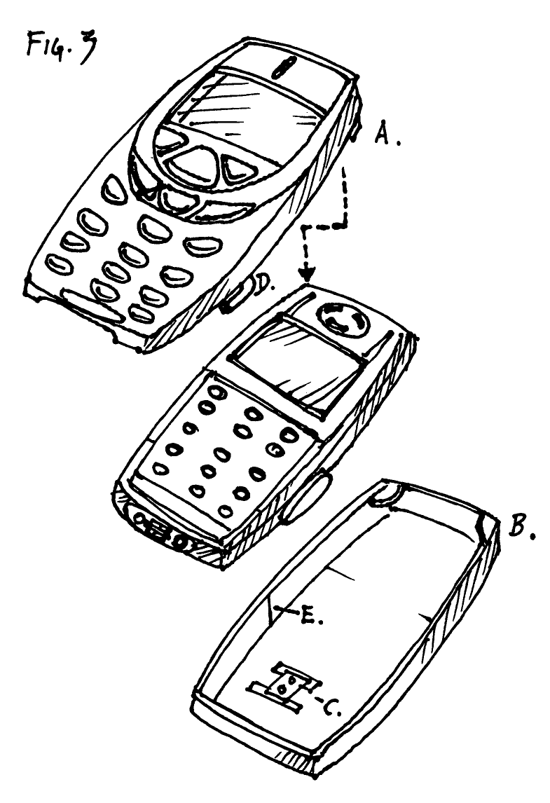

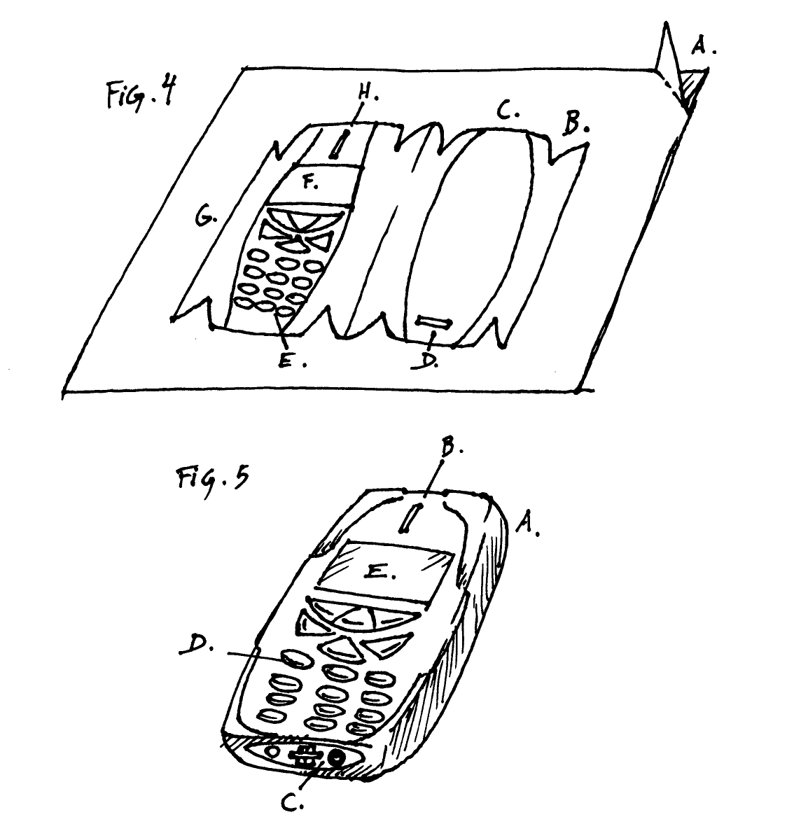

1. An overall improved cover for electronic devices such as cellular phones. The cover is comprised of a sheet of any material that is digitally or otherwise enhanced by a users choice and tastes.
(i) this sheet may be edited within an unobtrusive stencil.
(ii) this stencil may be perforated around its applicable areas for ease of removal from the main sheet.
(iii) the sheet may be textured selectively by films, doping processes, or any other method enhancing aesthetics, shock absorption, grip, or glare protection.
(iv) the sheet may be attached to the device by adhesives, or enclosed within a clear, tinted, or translucent case.
(v) a small perforation that allows for the integration of a clip or other method of attaching the device to other things.
